(19) United States
(12) Patent Application Publication
(10) Pub. No.: US 2010/0221550 A1
(43) Pub. Date: Sep. 2, 2010

(54) STRUCTURE FOR FLUORESCENT PASTER

(76) Inventor: Yuan Lin, Taipei City (TW)

Correspondence Address: APEX JURIS, PLLC, 12733 LAKE CITY WAY NORTHEAST, SEATTLE, WA, 98125, US

(21) Appl. No.: 12/778,528

(22) Filed: May 12, 2010

Related U.S. Application Data
(63) Continuation-in-part of application No. 11/882,079, filed on Jul. 30, 2007.

(30) Foreign Application Priority Data
Apr. 18, 2007 (TW) 096113591

(51) Int. Cl. B32B 27/38; B32B 27/14

(52) U.S. Cl. 428/413; 428/447

(57) ABSTRACT

A fluorescent paster generally comprises a light-pervious layer, a fluorescent powder layer, and a bonding layer. The light-pervious layer is mounted in a topmost position to emit a light beam. The fluorescent powder layer is formed directly under the light-pervious layer to change the color of the light beam when the light beam passes through the fluorescent powder layer. The bonding layer is formed under the fluorescent powder layer. As a result, the color of the light is changeable by means of the fluorescent powder layer and the fluorescent paster is attachable to an article by means of the bonding layer.

### FIELD OF THE INVENTION

The present invention relates to a structure for a fluorescent paster, and more particularly to a fluorescent paster that contains a fluorescent powder added therein to change the color of the light and is attachable to a lighting body such as a lamp bulb, a light-emitting diode, a lighting lamp bar or the like.

### BACKGROUND OF THE INVENTION

The invention of lamp bulbs that replace the earlier kerosene lamps changes human lives. With the process of high technologies, light-emitting diodes are invented, wherein the light-emitting diodes are capable of substituting for the lamp bulbs gradually so many high-tech companies are very zealous to develop related products.

For all existing light-emitting diodes, a junction is formed between a p-type semiconductor and an n-type semiconductor. If these two semiconductors are of the same material, this junction is called as a homojunction. If these two semiconductors are of different materials, this junction is called as a heterojunction. The heterojunction structure is generally utilized to increase the recombination probability of electrons and holes so that the energy gap of the middle light-emitting layer is smaller than that of the bilateral cladding layers. The heterojunction is such as AlGaN/GaN, GaInN/GaN or AlGaN/GaInN heterojunction.

The above-mentioned light-emitting diode can be made of a single material or a mixture of materials to obtain a required light color. However, other required light color cannot be obtained without manufacturing another light-emitting diode. At present, more and more locations and articles require many different light colors, but it is impossible to replace the light-emitting diode frequently to provide different light colors. Moreover, it is not easy to perform the replacement, which causes the increase of cost, resulting in the inconvenience.

Furthermore, for the purpose of change the color of light-emitting diode, the skill person in the art use adhesive materials, such as twin adhesive or glue, to attach phosphor sticker on objects. However, adhesive material of phosphor sticker has some drawbacks in poor UV resistance, light sheltered, viscous cannot be lasting due to the adhesive elements degrading, the diffident object sizes raise stocks and cost, and different materials causing bad paster effects.

In view of this, the present inventor makes diligent studies in providing the general public with a structure for a fluorescent paster to save manufacturing cost and save time in replacement so as to change the light color easily and increase the intensity of lighting.

### SUMMARY OF THE INVENTION

It is an object of the present invention to provide a structure for a fluorescent paster, wherein the fluorescent paster contains a fluorescent powder added therein to change the color of the light for providing the convenience in use.

It is another object of the present invention to provide a structure for a fluorescent paster, wherein the fluorescent paster is attachable to any shapes of lighting body for providing practicability in use.

It is a further object of the present invention to provide a structure for a fluorescent paster that surface of a light-pervious layer formed the micro lens structure for change the light emitting angles so as to increase the light emitting effects.

In order to achieve the foregoing objects, a fluorescent paster generally comprises a light-pervious layer, a fluorescent powder layer, and a bonding layer. The light-pervious layer is mounted in a topmost position to emit a light beam. The fluorescent powder layer is formed directly under the light-pervious layer to change the color of the light beam when the light beam passes through the fluorescent powder layer. The epoxy resin bonding layer is formed under the fluorescent powder layer. As a result, the color of the light is changeable by means of the fluorescent powder layer and the fluorescent paster is attachable to an article by means of the bonding layer.

The aforementioned and other objects and advantages of the present invention will be readily clarified in the description of the preferred embodiments and the enclosed drawings of the present invention.

### BRIEF DESCRIPTION OF THE DRAWINGS

FIG. 1 is an elevational view showing a fluorescent paster of the present invention.

FIG. 2 is a schematic view showing the fluorescent paster of the present invention.

FIG. 3 is a process diagram illustrating the manufacturing process of the fluorescent paster of the present invention.

FIG. 4 is a first embodying example of the fluorescent paster of the present invention.

FIG. 5 is a second embodying example of the fluorescent paster of the present invention.

### DETAILED DESCRIPTION OF THE PREFERRED EMBODIMENT

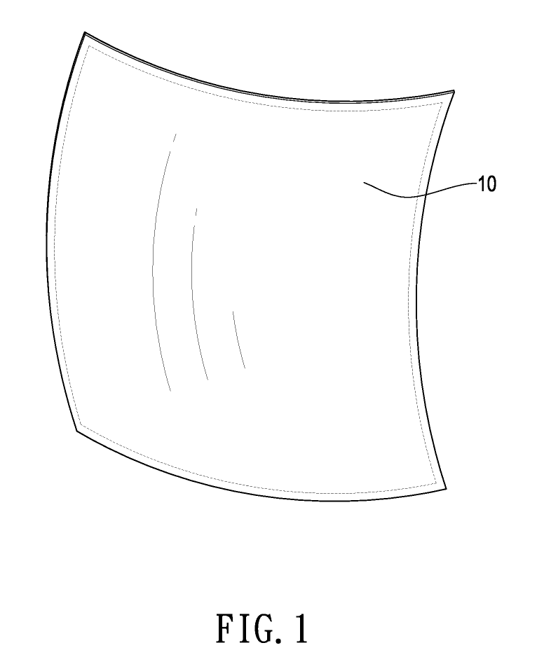

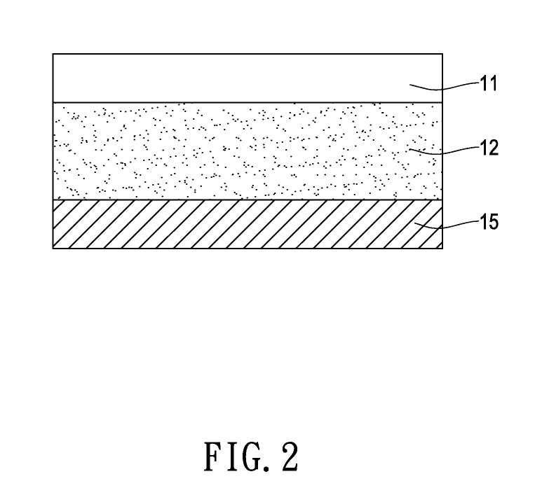

Referring to FIGS. 1 and 2, a fluorescent paster 10 of the present invention comprises a light-pervious layer 11, a fluorescent powder layer 12, and a bonding layer 15. The light-pervious layer 11 is located in a topmost position to emit light beams. Making of the light-pervious layer 11 is selected one material from the resin or epoxy resin, or alternatively selected one material from the group consisting polypropylene, polyethylene, polyvinylchloride (PVC), and polystyrene. Further, the light-pervious layer 11 has an option contains at least one Nano grade additives (i.e. Titanium Dioxide (TiO₂)) which provide protective effect to the fluorescent powder layer 12 and increase the light emitting effects. In addition, the surface of the light-pervious layer 11 also has an alternative that through the micro lens manufacture process to form a micro lens structure, wherein the micro lens structure can change the light emitting angles so as to increase the light emitting effects. The fluorescent powder layer 12 is located under the light-pervious layer 11. The fluorescent powder of the fluorescent powder layer 12 contains yttrium aluminum garnet or terbium aluminum garnet. Alternatively, the fluorescent powder may contain at least one material selected from the group consisting of magnesium tungstate, calcium tungstate, zinc silicate, lanthanum oxyfluoride and zinc sulfide or may contain at least one material selected from the group consisting of calcium, strontium, barium, zinc, cadmium, mercury, sulfur, selenium, manganese, copper, silver, europium and terbium. Accordingly, the color of the light can be changed by the fluorescent powder after the light beams pass through the fluorescent powder layer 12. The bonding layer 15 is formed under the fluorescent powder layer 12. And the bonding layer 15 is made of liquid-like or gelatinous transparent polysiloxanes resin (silicone) to be pervious to the light; and the bonding layer 15 to be stuck on any article before solidifying the bonding layer 15.

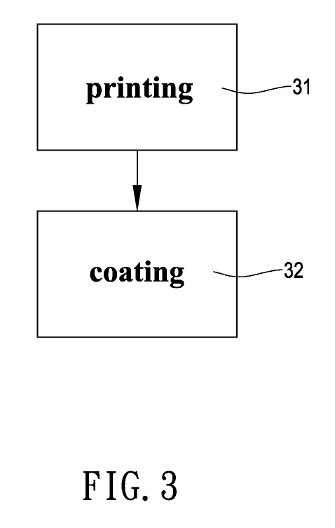

Referring to FIG. 3, a process diagram illustrating the manufacturing process of the fluorescent paster of the present invention is shown. The manufacturing process comprises: a printing step 31 for printing a fluorescent powder on one side of a bonding layer 15 so as to form a fluorescent powder layer; a coating step 32 for coating a transparent material on the fluorescent powder layer to form a light-pervious layer on the fluorescent powder layer; thereby completing the manufacture process of the fluorescent paster.

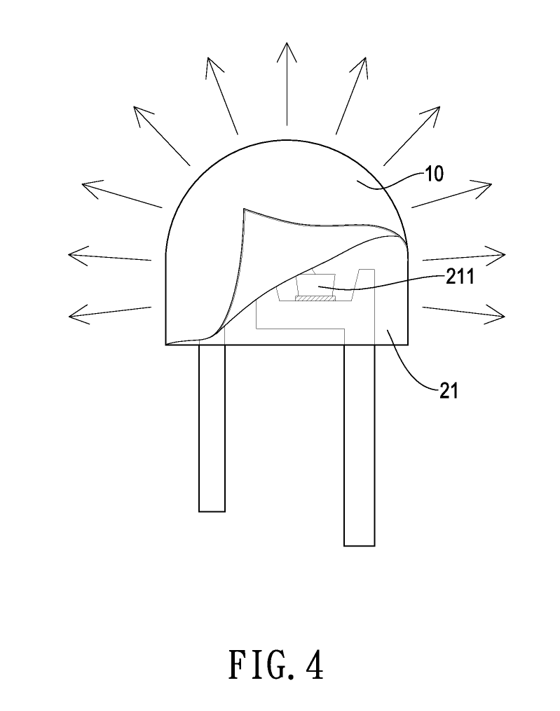

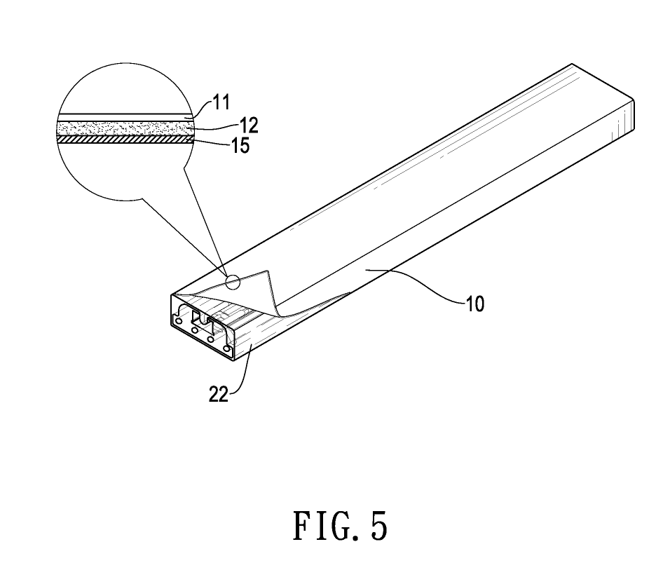

Referring to FIGS. 4 and 5, two embodying examples of the present invention are shown. The fluorescent paster is capable of changing the color of the light by means of the fluorescent powder contained therein. The fluorescent powder contains yttrium aluminum garnet or terbium aluminum garnet. Alternatively, the fluorescent powder may contain at least one material selected from the group consisting of magnesium tungstate, calcium tungstate, zinc silicate, lanthanum oxyfluoride and zinc sulfide or may contain at least one material selected from the group consisting of calcium, strontium, barium, zinc, cadmium, mercury, sulfur, selenium, manganese, copper, silver, europium, terbium, and any mixture thereof. As a result, the fluorescent powder may contain different ingredients so as to change the light beams into different colors. For example, the yttrium aluminum garnet can change the blue color of the light emitted from the light-emitting device into the white color. Further, for example, the yttrium aluminum garnet doped with terbium is green, the tin oxide doped with europium is red, the yttrium aluminum garnet doped with europium is red, the yttrium oxide doped with europium is pink, the zinc sulfide doped with manganese is orange-yellow, and the zinc sulfide doped with terbium and fluorine is orange-yellow. In this preferred embodiment, the fluorescent powder may contain different ingredients so as to change the light beams emitted from the light-emitting device into different colors. In addition, the bonding layer 15 is formed on one side of the fluorescent paster 10, wherein the bonding layer 15 can be stuck on any article before solidifying the bonding layer 15. After solidify (such as heat-solid process) the bonding layer 15, the fluorescent paster 10 is attachable bond on the article directly.

As shown in FIG. 4, the fluorescent paster 10 is bonded on an existing light-emitting diode 21 so as to change the color of the light emitted from a chip 211. The fluorescent paster 10 comprises a light-pervious layer 11, a fluorescent powder layer 12 and a bonding layer 15, wherein the light-pervious layer 11 is a resin, epoxy resin, polypropylene, polyethylene, polyvinylchloride (PVC), or polystyrene, and locates in a topmost position to emit light beams. The epoxy resin is generally cured by reaction with acid anhydride, wherein a major agent and a curing agent must be uniformly mixed before use. The major agent comprises epoxy oligomer, viscosity-adjusting agent, coloring agent, etc. The curing agent comprises acid anhydride and catalyst/curing accelerator. The physical property of the cured epoxy resin is changeable by the change in the ratio of major agent to curing agent. It is generally prepared by using an equivalent ratio of 1:1 to obtain most proper property. Furthermore, the light-pervious layer 11 has an option add at least one Nano grade additives (i.e. Titanium Dioxide (TiO₂)) which provide protective effect to the fluorescent powder layer 12 and increase the light emitting effects. additionally, the surface of the light-pervious layer 11 may have forming a micro lens structure which through the micro lens manufacture process, wherein the micro lens structure can change the light emitting angles so as to increase the light emitting effects. The fluorescent powder layer 12 is located under the light-pervious layer 11 so that the fluorescent powder layer 12 can change the color of the light when the light passes through the fluorescent powder layer 12. The viscous polysiloxanes resin (silicone) made bonding layer 15 is located under the fluorescent powder layer 12.

As shown in FIG. 5, the fluorescent paster 10 to be stuck on a lighting lamp bar 22 so that the light color of the lighting lamp bar 22 is diversely changeable to beautify appearance.

From the foregoing description, the structure and the manufacturing method of the present invention have the following advantages:

1. Various light colors are obtainable by combining the fluorescent powder with the fluorescent paster so that the production cost and the manufacturing cost can be reduced.

2. The fluorescent paster can be widely applied to the light-emitting device, thereby increasing the convenience and practicability in use.

3. Through added the Nano grade additives (i.e. Titanium Dioxide (TiO₂)) into the light-pervious layer or forming a micro lens structure to the surface of the light-pervious layer, which provide the light emitting angles change and increase the light emitting effects.

4. Combine bottom layer and adhesive layer of prior art, new design of bonding layer has advantages of fast manufacture, no light sheltered caused by glue elements, moisture-proof, suitable for attached to non-flat surface (i.e. light bulb), and low quantity production as well.

To sum up, the present invention is capable of achieving the aforementioned objects. Therefore, this application is filed according to the patent law.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments, which do not depart from the spirit and scope of the invention.

What is claimed is:

1. A fluorescent paster, comprising:
a light-pervious layer mounted in a topmost position to emit a light beam;
a fluorescent powder layer is formed directly under said light-pervious layer to change the color of said light beam by means of a fluorescent powder contained therein when said light beam passes through said fluorescent powder layer; and
a bonding layer made of polysiloxanes resin is mounded under said fluorescent powder layer, whereby the color of said light beam is changeable by means of said fluorescent powder layer and said fluorescent paster is attachable to an article by means of said bonding layer.

2. A fluorescent paster according to claim 1, wherein said fluorescent powder of said fluorescent powder layer contains at least one material selected from yttrium aluminum garnet or terbium aluminum garnet.

3. A fluorescent paster according to claim 1, wherein said fluorescent powder of said fluorescent powder layer contains at least one material selected from the group consisting of magnesium tungstate, calcium tungstate, zinc silicate, lanthanum oxyfluoride and zinc sulfide.

4. A fluorescent paster according to claim 1, wherein said fluorescent powder of said fluorescent powder layer contains at least one material selected from the group consisting of calcium, strontium, barium, zinc, cadmium, mercury, sulfur, selenium, manganese, copper, silver, europium and terbium.

5. A fluorescent paster according to claim 1, wherein said bonding layer is made of at least one material state selected from liquid-like or gelatinous polysiloxanes resin.

6. A fluorescent paster according to claim 1, wherein said surface of said light-pervious layer is micro lens structure.

7. A fluorescent paster according to claim 1, wherein said light-pervious layer is a resin.

8. A fluorescent paster according to claim 1, wherein said light-pervious layer is an epoxy resin.

9. A fluorescent paster according to claim 1, wherein said light-pervious layer is selected from the group consisting of polypropylene, polyethylene, polyvinylchloride, and polystyrene.

10. A fluorescent paster according to claim 1, wherein said light-pervious layer contains the Nano grade additives.

11. A fluorescent paster according to claim 10, wherein said Nano grade additives of said light-pervious layer is Titanium Dioxide.
